(19) United States
(12) Patent Application Publication
(10) Pub. No.: US 2016/0275842 A1
(43) Pub. Date: Sep. 22, 2016

(54) DISPLAY DEVICE AND METHOD OF DRIVING A DISPLAY DEVICE

(71) Applicant: Samsung Display Co., Ltd., Yongin-si (JP)

(72) Inventor: Ju-Gon Seok, Suwon-si (KR)

(21) Appl. No.: 14/836,182

(22) Filed: Aug. 26, 2015

(30) Foreign Application Priority Data
Mar. 16, 2015 (KR) 10-2015-0035707

(51) Int. Cl. G09G 3/20; G09G 3/32

(52) U.S. Cl. CPC G09G 3/2003; G09G 3/3208; G09G 2320/0276; G09G 2310/0218

(57) ABSTRACT

A display device and a method of driving a display device are disclosed. In one aspect, the display device includes a display panel including a plurality of pixels and a gamma voltage generator configured to i) determine a plurality of gamma voltages respectively corresponding to a plurality of grayscales, ii) independently determine a black gamma voltage corresponding to a black grayscale, and iii) output the black gamma voltage based on black load variation corresponding to the change of a black load between a plurality of frames. A display panel driver is configured to drive the display panel based on the gamma voltages including the black gamma voltage.

### INCORPORATION BY REFERENCE TO ANY PRIORITY APPLICATIONS

This application claims priority from and the benefit of Korean Patent Applications No. 10-2015-0035707, filed on Mar. 16, 2015 in the Korean Intellectual Property Office (KIPO), the disclosure of which is hereby incorporated by reference herein in its entirety.

### BACKGROUND

1. Field

The described technology generally relates to display devices and methods of driving display devices.

2. Description of the Related Technology

An organic light-emitting diode (OLED) display generates an emission current corresponding to a voltage difference between a power supply voltage and a data voltage. Luminance and grayscale of light emitted from a pixel is adjusted according to an amount of driving current. The luminance and the grayscale are controlled based on the level of gamma voltages. Here, a black gamma voltage is one of the gamma voltages that represents a black grayscale.

### SUMMARY OF CERTAIN INVENTIVE ASPECTS

One inventive aspect relates to a display device selecting an independent and adaptive black gamma voltage.

Another aspect is a method for driving the display device.

Another aspect is a display device that comprises a display panel including a plurality of pixels, a gamma voltage generator configured to determine a plurality of gamma voltages respectively corresponding to a plurality of grayscales, independently determine a black gamma voltage corresponding to a black grayscale, and adaptively output the black gamma voltage based on a black load variation, and a display panel driver configured to drive the display panel based on the gamma voltages including the black gamma voltage.

In example embodiments, the black load is a ratio of black pixels among entire pixels.

In example embodiments, the black load is determined based on a black load variation and a magnitude of the black load.

In example embodiments, the gamma voltage generator includes a load detector configured to detect the black load in a predetermined frame, a black gamma voltage selector configured to adjust the black gamma voltage based on the black load, and a gamma voltage selector configured to adjust the gamma voltage except the black gamma voltage.

In example embodiments, the load detector analyzes image data received from an external device to detect a detected black load.

In example embodiments, the black gamma voltage selector linearly changes the black gamma voltage over a plurality of frames such that the black gamma voltage reaches a target black gamma voltage which corresponds to the detected black load.

In example embodiments, the black gamma voltage selector includes a lookup table (LUT) that stores a plurality of LUT voltage values corresponding to a plurality of reference points which point different magnitudes of the black load.

In example embodiments, the black gamma voltage selector performs a linear interpolation between a first voltage corresponding to an (N)th black load, that is the black load of an (N)th frame, and a second voltage corresponding to one of the reference points which is nearest to an (N+1)th black load, that is the black load of an (N+1)th frame, and determines the black gamma voltage of the (N+1)th frame based on the linear interpolation, where N is a positive integer.

In example embodiments, the black gamma voltage selector outputs the black gamma voltage of the (N+1)th frame having substantially the same as the black gamma voltage of the (N)th frame when the (N)th and (N+1)th black loads are in a predetermined static load range.

In example embodiments, the black gamma voltage selector outputs the black gamma voltage of the (N+1)th frame corresponding to the (N+1)th black load when the black load variation between the (N)th black load and the (N+1)th black load is greater than a predetermined reference value.

In example embodiments, the black gamma voltage selector further includes a calculator configured to calculate a black load variation based on the detected black load, and a determiner configured to adaptively adjust an output of the black gamma voltage based on a magnitude of the black load and the black load variation.

In example embodiments, the black gamma voltage selector adjusts a black gamma voltage variation and the number of frames in which the black gamma voltage is linearly changed based on the black load variation.

In example embodiments, the gamma voltage generator decreases the black gamma voltage linearly as the black load decreases.

In example embodiments, each of the pixels includes an organic light emitting diode (OLED).

In example embodiments, the display panel driver includes a scan driver configured to provide a scan signal to the display panel, a data driver configured to provide a data voltage generated based on the gamma voltages to the display panel, and a timing controller configured to control the gamma voltage generator, the scan driver, and the data driver.

Another aspect is a method of driving a display device that comprises detecting a black load of a display panel, adaptively determining a black gamma voltage of a current frame which corresponds to a black grayscale based on the black load of a previous frame and a black load variation, determining a plurality of gamma voltages except for the black gamma voltage based on input image data.

In example embodiments, the black gamma voltage is determined based on the black load variation and a magnitude of the black load.

In example embodiments, determining the black gamma voltage includes changing an output of the black gamma voltage linearly using a linear interpolation method, when the black load variation is less than or substantially equal to a predetermined reference value.

In example embodiments, determining the black gamma voltage further includes maintaining the output of the black gamma voltage of the previous frame for the current frame, when the black load of the previous frame and the black load of the current frame are in a predetermined static load range.

In example embodiments, determining the black gamma voltage further includes selecting the black gamma voltage corresponding to the black load of the current frame, when the black load variation is greater than the reference value.

Another aspect is a display device, comprising: a display panel including a plurality of pixels; a gamma voltage generator configured to i) determine a plurality of gamma voltages respectively corresponding to a plurality of grayscales, ii) independently determine a black gamma voltage corresponding to a black grayscale, and iii) output the black gamma voltage based on black load variation corresponding to the change of a black load between a plurality of frames; and a display panel driver configured to drive the display panel based on the gamma voltages including the black gamma voltage.

In the above display device, the pixels include black pixels, and wherein the black load is a ratio of the black pixels to all the pixels.

In the above display device, the gamma voltage generator is configured to determine the black load based on the black load variation and a magnitude of the black load.

In the above display device, the gamma voltage generator includes: a load detector configured to detect the black load in a predetermined frame; a black gamma voltage selector configured to select the black gamma voltage based on the black load; and a gamma voltage selector configured to select the gamma voltage except the black gamma voltage.

In the above display device, the load detector is further configured to receive image data from an external device and analyze the received image data so as to detect the black load.

In the above display device, the black gamma voltage selector is further configured to linearly change the black gamma voltage over a plurality of frames such that the black gamma voltage reaches a target black gamma voltage corresponding to the detected black load.

In the above display device, the black gamma voltage selector includes a lookup table (LUT) configured to store a plurality of LUT voltage values corresponding to a plurality of reference points corresponding to different magnitudes of the black load.

In the above display device, the black gamma voltage selector is further configured to a linearly interpolate a black gamma voltage of an (N+1)th frame between a first voltage corresponding to an (N)th black load, that is the black load of an (N)th frame, and a second voltage corresponding to one of the reference points located nearest to an (N+1)th black load, that is the black load of the (N+1)th frame, where N is a positive integer.

In the above display device, the black gamma voltage selector is further configured to output the black gamma voltage of the (N+1)th frame and the black gamma voltage of the (N)th frame to have substantially the same value when the (N)th and (N+1)th black loads are within a predetermined static load range.

In the above display device, the black gamma voltage selector is further configured to output the black gamma voltage of the (N+1)th frame corresponding to the (N+1)th black load when the black load variation between the (N)th black load and the (N+1)th black load is greater than a predetermined reference value.

In the above display device, the black gamma voltage selector further includes: a calculator configured to calculate a black load variation based on the detected black load; and a determiner configured to adjust an output of the black gamma voltage based on a magnitude of the black load and the black load variation.

In the above display device, the black gamma voltage selector is further configured to select a black gamma voltage variation, corresponding to a change of the black gamma voltage between two frames, and the number of the frames in which the black gamma voltage changes linearly based on the black load variation.

In the above display device, the gamma voltage generator is further configured to decrease the black gamma voltage when the black load decreases.

In the above display device, each of the pixels includes an organic light-emitting diode (OLED).

In the above display device, the display panel driver includes: a scan driver configured to provide a scan signal to the display panel; a data driver configured to provide a data voltage generated based on the gamma voltages to the display panel; and a timing controller configured to control the gamma voltage generator, the scan driver, and the data driver.

Another aspect is a method of driving a display device, comprising: detecting a black load of a display panel; determining a black gamma voltage of a current frame which corresponds to a black grayscale based on the black load of a previous frame and black load variation corresponding to the change of a black load between the frames; and determining a plurality of gamma voltages except for the black gamma voltage based on input image data.

In the above method, the black gamma voltage is determined based on the black load variation and a magnitude of the black load.

In the above method, determining the black gamma voltage includes changing an output of the black gamma voltage via a linear interpolation method, when the black load variation is less than or substantially equal to a predetermined reference value.

In the above method, determining the black gamma voltage further includes maintaining the output of the black gamma voltage of the previous frame as the output of the black gamma voltage of the current frame, when the black load of the previous frame and the black load of the current frame are within a predetermined static load range.

In the above method, determining the black gamma voltage further includes selecting the black gamma voltage corresponding to the black load of the current frame, when the black load variation is greater than the reference value.

According to at least one of the disclosed embodiments, the display device includes the gamma voltage generator to independently and adaptively determine the black gamma voltage. Accordingly, the black gamma voltage can be linearly changed or maintained based on the black load (or a ratio of black grayscale), so that color blurring and color band appearance problems according to grayscale change (or an emission delay) can be improved.

In addition, the method of driving the display device according to example embodiments can adaptively and independently determine the black gamma voltage based on the black load (or the grayscale change). Thus, color blurring and color band appearance by the emission delay can be improved.

### BRIEF DESCRIPTION OF THE DRAWINGS

FIG. 1 is a block diagram of a display device according to example embodiments.

FIG. 2 is diagram illustrating an example of an emission delay of a display device.

FIG. 3 is a block diagram illustrating an example of a gamma voltage generator included in the display device of FIG. 1.

FIG. 4 is a diagram illustrating an example of a black gamma voltage determined by the gamma voltage generator of FIG. 3.

FIG. 5 is a diagram illustrating another example of a black gamma voltage determined by the gamma voltage generator of FIG. 3.

FIG. 6 is a block diagram illustrating an example of a black gamma voltage selector included in the gamma voltage generator of FIG. 3.

FIG. 7 is a flowchart of a method of driving a display device according to example embodiments.

FIG. 8 is a flowchart illustrating an example of a method of determining a black gamma voltage in the driving method of FIG. 7.

### DETAILED DESCRIPTION OF CERTAIN INVENTIVE EMBODIMENTS

An OLED initialization circuit is applied in a pixel to prevent an unexpected emission from the OLED. An anode of the OLED is initialized to have an initialization voltage in accordance with an operation of the initialization circuit. Accordingly, a driving voltage charging time for emitting the OLED can be longer in one frame. Thus, an emission delay according to the driving voltage charging time can occur. Image degradation such as color shift, color blurring, color band appearance, etc. is caused by the emission delay.

Typical display devices commonly determine (or control) the gamma voltages including the black gamma voltage. The gamma voltages are also adjusted in a stepwise manner corresponding to the grayscale or luminance. This method for determining the gamma voltages cannot solve the image degradation caused by the emission delay.

Exemplary embodiments will be described more fully hereinafter with reference to the accompanying drawings, in which various embodiments are shown. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

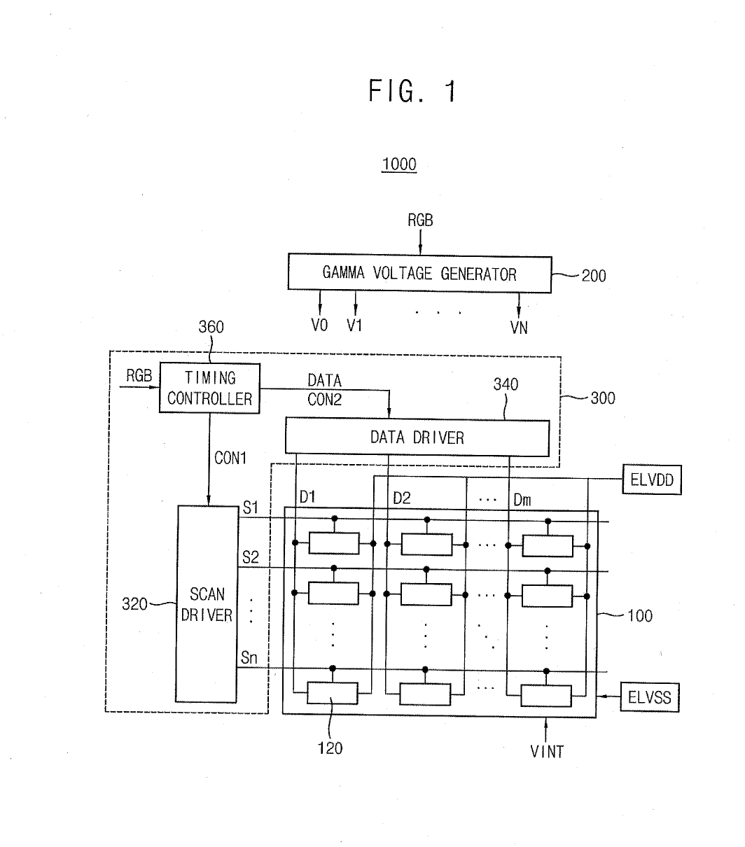

FIG. 1 is a block diagram of a display device according to example embodiments. Depending on embodiments, certain elements may be removed from or additional elements may be added to the display device 1000 illustrated in FIG. 1. Furthermore, two or more elements may be combined into a single element, or a single element may be realized as multiple elements. This also applies to the remaining disclosed embodiments.

Referring to FIG. 1, a display device 1000 includes a display panel 100, a gamma voltage generator 200,and a display panel driver 300. In some embodiments, the display panel driver 300 includes a scan driver 320, a data driver 340, and a timing controller 360.

The display panel 100 can include a plurality of pixels 120. The display panel 100 can be connected to the scan driver 320 via a plurality of scan lines S1 to Sn. The display panel 100 can be connected to the data driver 340 via a plurality of data lines D1 to Dm. The display panel 100 can include M (M is a positive integer) of pixel columns each connected to the respective data lines D1 through Dm and N (N is a positive integer) of pixel rows each connected to the respective scan lines S1 through Sn. Thus, the pixels 120 can be arranged in a matrix form and the display panel 100 can include N*M pixels. In some embodiments, each of the pixels 120 includes an organic light-emitting diode (OLED). Thus, the display device 1000 can be an OLED display. The pixels 120 can emit light and display an image by receiving a first power voltage ELVDD, a second power voltage ELVSS, and a data voltage which is applied from the data driver 340. Each of the pixels 120 can include an initialization circuit to initialize the OLED in every frame. Thus, an initialization voltage VINIT can be applied to the pixels 120. The initialization circuit can initialize an anode of the OLED to prevent unexpected emission which occurs by leakage current at a switching element in the pixel 120.

The gamma voltage generator 200 can determine a plurality of gamma voltages V0 to VN corresponding to a plurality of grayscales, respectively. The gamma voltage generator 200 can independently determine a black gamma voltage V0 corresponding to a black grayscale and adaptively output the black gamma voltage V0 based on a black load variation. The gamma voltage generator 200 can provide the gamma voltages V0 to VN to the data driver 340 in the display panel driver 300. In some embodiments, the gamma voltages V0 to VN are classified into 64 gamma voltages of 64 grayscales or 256 gamma voltages of 256 grayscales. Since these are examples, the number of gamma voltages is not limited thereto. In some embodiments, the black load is a ratio of black pixels (or black image) among entire pixels (or entire image). The black gamma voltage V0 can be determined based on the black load variation and a magnitude of the black load. For example, the gamma voltage generator 200 linearly increases or decreases the black gamma voltage V0 based on the black load variation (or difference) between the black load of a previous frame and the black load of a current frame. For example, the gamma voltage generator 200 linearly decreases the black gamma voltage level when the black load decreases.

In some embodiments, the gamma voltage generator 200 receives input image data RGB from an external device, and analyzes the input image data RGB to detect the black load.

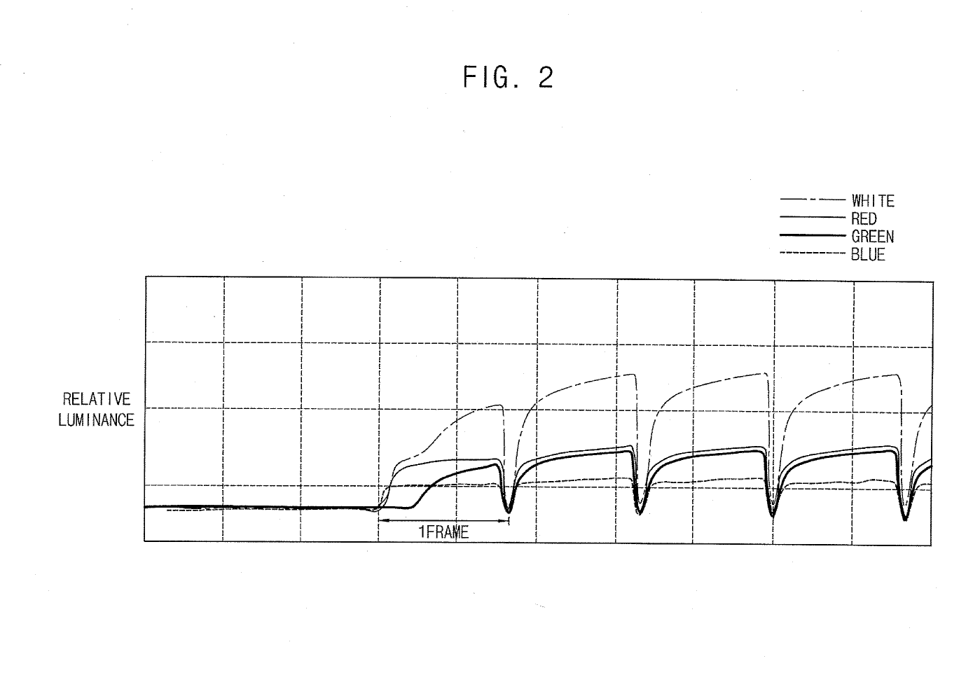

In some embodiments, the gamma voltage generator 200 includes a black load detector to detect the black load in a predetermined frame, a black gamma voltage selector to output the black gamma voltage V0, and a gamma voltage selector to output the gamma voltage V1 to VN except the black gamma voltage V0. The black gamma voltage selector can adaptively determine the black gamma voltage V0 under a certain condition. Example embodiments of constructions and operations of the gamma voltage generator 200 and the black gamma voltage selector will be described in detail with reference to FIGS. 2 to 6.

The display panel driver 300 can drive the display panel 100 based on the gamma voltage V0 to VN including the black gamma voltage V0. In some embodiments, the display panel driver 300 includes the scan driver 320, the data driver 340, and the timing controller 360.

The scan driver 320 can provide a scan signal to the display panel 100 via the scan lines Si to Sn. In some embodiments, each of the scan lines S1 to Sn is connected to pixel 120 arranged in one of the pixel rows.

The data driver 340 can provide a data voltage which is generated based on selected gamma voltages V0 and VN to the display panel 100 via the data lines D1 to Dm. The data driver 340 can generate analog data voltage using image data DATA receiving from the timing controller 360 and the gamma voltages V0 to VN receiving from the gamma voltage generator 200.

The timing controller 360 can control the scan driver 320 and the data driver 340 based on first and second control signals CON1 and CON2. In some embodiments, the timing controller 360 receives an input control signal and the input image data DATA from an image source, e.g., an external graphic apparatus. The input control signal can include a main clock signal, a vertical synchronizing signal, a horizontal synchronizing signal, and a data enable signal. The timing controller 360 can generate digital image data DATA corresponding to operating conditions of the display panel 100 based on the input image data DATA and provide the image data DATA to the data driver 340.

As described above, the gamma voltage generator in the display device 1000 according to example embodiments can set (or determine) the black gamma voltage V0 regardless of the others (V1 to VN). The gamma voltage generator 200 can adaptively select the black gamma voltage V0 based on the magnitude of detected black load and the black load variation. Thus, emission delay can be prevented and the image quality can be improved.

FIG. 2 is diagram illustrating an example of an emission delay of a display device.

FIG. 2 shows measured waveforms of relative luminance of color lights emitted from pixels. Referring to FIG. 2, when a black gamma voltage is continuously output to have a certain voltage level, emission delays of the pixels can occurs.

As the efficiency of the OLED is improved, an expected emission form the pixel by leakage current in a pixel circuit can be increased. Thus, an initialization circuit can be applied to the pixel circuit to solve the expected emission problem. The initialization circuit can apply an initialization voltage to an anode of the OLED for a certain period in one frame to initialize the OLED. Thus, a residual current of a previous frame or the leakage current cannot influence an operation of the OLED. Configuration of the initialization circuit can be implemented by known techniques.

After the initialization period, the pixel circuit charges a data voltage to emit desired light such that the time delay occurs. In some embodiments, the pixels include a red pixel emitting red light, a green pixel emitting green light, and a blue pixel emitting blue light.

As illustrated in FIG. 2, the green pixel is driven by a driving voltage lower than the driving voltages of the red and blue pixels such that the emission delay at the green pixel is relatively long compared to the red and blue pixels. Thus, color blurring and color band appearance by the emission delay can be seen.

Accordingly, the display device 100 according to example embodiments adjusts adaptively the black gamma voltage based on the change of the black load so that the image degradation by the emission delay can be improved.

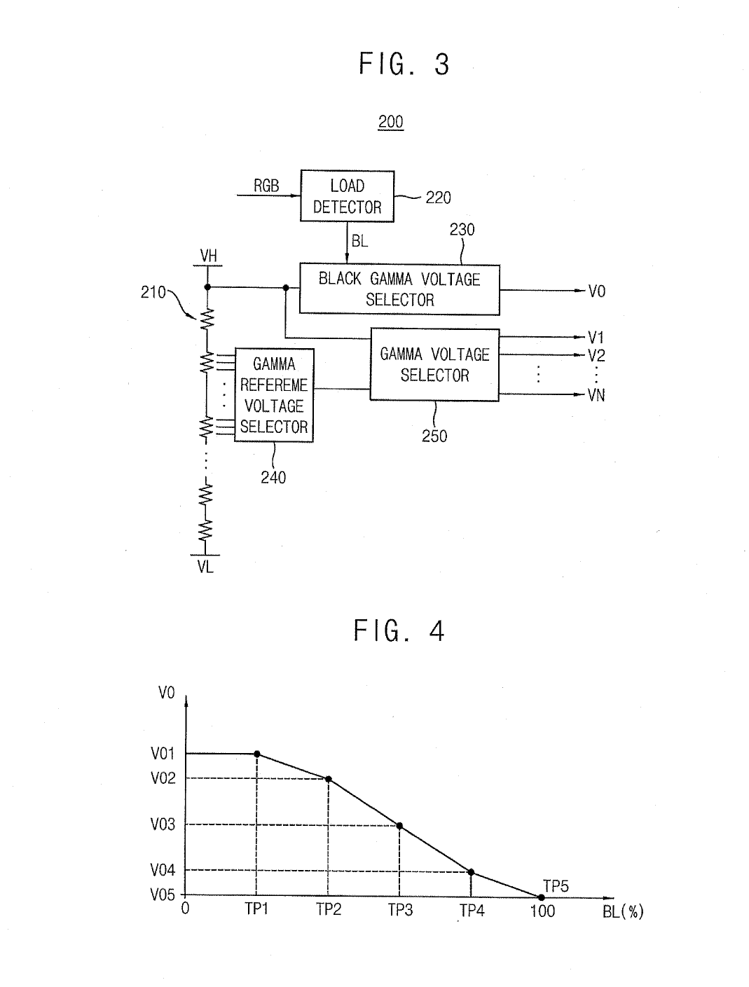

FIG. 3 is a block diagram illustrating an example of a gamma voltage generator included in the display device of FIG. 1. FIG. 4 is a diagram illustrating an example of a black gamma voltage determined by the gamma voltage generator of FIG. 3.

Referring to FIGS. 1, 3, and 4, the gamma voltage generator 200 includes a load detector 220, a black gamma voltage selector 240, a gamma voltage selector 250.

In some embodiments, the gamma voltage generator 200 further includes a resistor string 210 having a plurality of resistors connected in series with each other to divide first and second voltages VH and VL to a plurality of gamma reference voltages, and a gamma reference voltage selector 240 selecting one of the gamma reference voltages. In some embodiments, the first voltage VH corresponds to an uppermost voltage and the second voltage VL corresponds to a lowermost voltage or a ground voltage. Here, each of the gamma reference voltages can have a voltage level between the first and second voltages VH and VL. The gamma reference voltage selector 240 can provide the selected gamma reference voltage to the gamma voltage selector 250.

The load detector 220 can detect a black load BL every predetermined frame. The black load BL can be a ratio of black pixels (or black image) to all the pixels (or entire image). The black load BL can have a value between 0% to 100% (or, 0 to 1). In some embodiments, the load detector 220 receives input image data RGB from an external device, and analyzes the input image data RGB to detect the black load BL. For example, when the ratio of the black image among the entire image is about 30% in a specific frame, the load detector 220 outputs the black load BL having about 30% or about 0.3. When the detected black load is about 100%, the entire image is substantially black. When the detected black load is about 0, there is substantially no black pixel. In some embodiments, the load detector 220 detects the black load BL every frame. In some embodiments, the load detector 220 detects the black load BL at regular interval frames.

The black gamma voltage selector 230 can receive the black load BL and the first voltage VH. The black gamma voltage selector 230 can adjust the black gamma voltage V0 based on the black load BL and the first voltage VH. In some embodiments, the black gamma voltage selector 230 selects the black gamma voltage using a black load BL variation and a magnitude of the black load BL.

In some embodiments, the black gamma voltage selector 230 includes a table including a plurality of black gamma voltage levels corresponding to magnitudes of the black loads, respectively. In some embodiments, the black gamma voltage selector 230 further includes a lookup table that stores a plurality of LUT voltage values corresponding to a plurality of reference points which refer to different magnitudes of the black load. For example, as illustrated in FIG. 4, first to fifth black gamma voltages V01 to V05 corresponding to first to fifth reference points TP1 to TP5, that define 5 black loads, are determined or stored at the lookup table. Further, the other black gamma voltages corresponding to the black loads except the first to fifth reference points TP1 to TP5 can be linearly determined by the first to fifth black gamma voltages V01 to V05.

The black gamma voltage selector 230 can compare the black load BL of a previous frame and the black load BL of a current frame and adaptively calculate the black gamma voltage V0 of the current frame.

In some embodiments, the black gamma voltage selector 230 performs a linear interpolation between a first voltage corresponding to an (N)th black load, that is the black load BL of an (N)th frame, and a second voltage corresponding to one of the reference points TPO to TP5 which is nearest to an (N+1)th black load, that is the black load BL of an (N+1)th frame. The black gamma voltage selector 230 can determine the black gamma voltage V0 of the (N+1)th frame based on the linear interpolation. For example, when the (N)th black load corresponds to the second reference point TP2, the (N+1)th black load corresponds to the third reference point TP3, and the black gamma voltage BL of the (N)th frame corresponds to a voltage level V02, the black gamma voltage selector 230 can determine the black gamma voltage V0 of the (N+1)th frame by the linear interpolation between the voltage levels V02 and V03. In this, the black gamma voltage of the (N+1)th frame can be between the voltage levels V02 and V03.

The black gamma voltage V0 can linearly decrease over several frames (e.g., (k) frames) when the black load BL changes from the second reference point TP2 to the third reference point TP3, so that the black gamma voltage V0 can reach a voltage level V03 corresponding to the third reference point TP3 after the (k) frames. In some embodiments, the black gamma voltage selector 230 adjusts a range of the black gamma voltage variation and the number of frames in which the black gamma voltage is linearly changed based on the black load variation. For example, the black gamma voltage variation is adjusted with an adjustment of the number of the frames in which the black gamma voltage is linearly changed. Thus, in some embodiments, the black gamma voltage V0 does not change drastically during the frames such that the display device 100 can prevent flickering images.

Accordingly, the black gamma voltage V0 is linearly changed due to the black load BL change such that the black gamma voltage V0 does not change drastically. Thus, in some embodiments, color blurring, flickering, and color band appearance can be not seen.

In some embodiments, the black gamma voltage selector 230 outputs the black gamma voltage V0 of the (N+1)th frame having substantially the same as the black gamma voltage V0 of the (N)th frame when the (N)th and (N+1)th black loads are within a predetermined static load range. For example, when the black load BL changes within a very low black load range (e.g., the range corresponding to about 0 to about 30%) and the black gamma voltage V0 changes, luminance/grayscale changes of the black image can be visible to users. Thus, when the black load BL changes within the predetermined static load range, the black gamma voltage selector 230 can maintain the output voltage level of the black gamma voltage V0. As illustrated in FIG. 4 the black gamma voltage selector 230 can determine the black gamma voltage V0 to be a voltage level V01 with respect to a black load range (i.e., the static load range) 0 to the first reference point TP1. Thus, when the black load BL changes within the static load range 0 to TP1, the black gamma voltage selector 230 can continuously output the black gamma voltage V0 having the voltage level V01.

In some embodiments, the black gamma voltage selector 230 outputs the black gamma voltage V0 of the (N+1)th frame corresponding to the (N+1)th black load when the black load variation between the (N)th black load and the (N+1)th black load is greater than a predetermined reference value. For example, the reference value is set about 70%. Here, when the black load variation is greater than about 70% (i.e., the reference value), the black gamma voltage V0 in the (N+1)th frame can have a voltage level corresponding to the (N+1)th black load. When the black load BL changes drastically, for example, the black load BL increases drastically (e.g., from about 10% to about 90%), the users do not recognize a black grayscale change. In this case, the black gamma voltage selector 230 can non-linearly output, e.g., step-functionally output, the black gamma voltage V0.

The gamma voltage selector 250 can adjust the gamma voltage V1 to VN and not the black gamma voltage V0. The gamma voltage selector 250 can select the gamma voltages V1 to VN based on the gamma reference voltages and the input image data RGB. In some embodiments, the gamma voltage selector 250 includes resistor strings to divide the gamma reference voltages.

As described above, the display device according to example embodiments can include the black gamma voltage selector 220 to adaptively and independently control the black gamma voltage V0 based on the magnitude of the black load BL and the black load variation. Thus, color blurring and color band appearance problems by the initialization of the pixel can be improved.

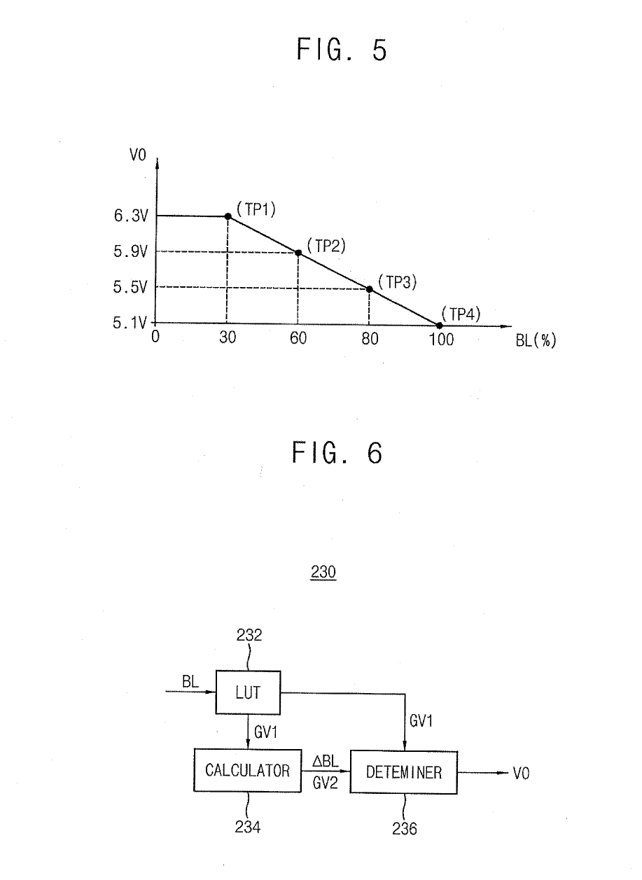

FIG. 5 is a diagram illustrating another example of a black gamma voltage determined by the gamma voltage generator of FIG. 3.

Referring to FIGS. 1 to 5, the gamma voltage generator 200 adaptively adjusts the black gamma voltage V0 based on the magnitude of the black load BL and the black load variation.

In some embodiments, as illustrated in FIG. 5, the gamma voltage generator 200 sets first to fourth reference points TP1 to TP4 respectively corresponding to about 30%, about 60%, about 80%, and about 100% black loads BL. T gamma voltage generator 200 can set voltage levels of the black gamma voltage V0 to have about 6.3V, about 5.9V, about 5.5V, and about 5.1V, respectively. When the (N)th black load changes to the (N+1)th black load and the magnitude of the (N+1)th black load is maintained, the gamma voltage generator 200 can adaptively output the black gamma voltage V0 according to the magnitudes of the (N)th and (N+1)th black loads.

In some embodiments, the magnitude of the (N)th black load is about 30% and the magnitude of the (N+1)th black load is about 60%, an output of the black gamma voltage can be substantially the same as [Table 1] below.

TABLE 1

| BL/Frame | n | n + 1 | n + 2 | n + 3 | n + 4 | n + 5 |
|---|---|---|---|---|---|---|
| 30% → 60% | 6.3 V | 6.2 V | 6.1 V | 6.0 V | 5.9 V | 5.9 V |

In this case, the black gamma voltage V0 can be linearly decreased over 4 frames.

As illustrated in FIG. 5, in some embodiments, the black gamma voltage V0 does not change within a static load range about 0 to about 30%. In some embodiments, when the (N)th black load is about 0% and the(N+1)th gamma load is about 30%, the output of the black gamma voltage can be substantially the same as [Table 2] below.

TABLE 2

| BL/Frame | n | n + 1 | n + 2 | n + 3 | n + 4 | n + 5 |
|---|---|---|---|---|---|---|
| 0% → 30% | 6.3 V | 6.3 V | 6.3 V | 6.3 V | 6.3 V | 6.3 V |

In this case, the black gamma voltage selector 230 can maintain the output voltage level of the black gamma voltage V0 to have about 6.3V.

In some embodiments, when the black load variation between the (N)th black load and the (N+1)th black load is greater than a predetermined reference value, the black gamma voltage selector 230 can output the black gamma voltage of the (N+1)th frame corresponding to the (N+1)th black load at the (N+1)th frame. For example, the reference value is set to about 60%. Here, when the (N)th black load is about 0% and the (N+1)th gamma load is about 60%, the output of the black gamma voltage can be substantially the same as [Table 3] below.

TABLE 3

| BL/Frame | n | n + 1 | n + 2 | n + 3 | n + 4 | n + 5 |
|---|---|---|---|---|---|---|
| 0% → 60% | 6.3 V | 5.9 V | 5.9 V | 5.9 V | 5.9 V | 5.9 V |

In this case, the output of the black gamma voltage can change non-linearly (e.g., step-functionally).

Since operations of the black gamma selector 230 are described above with reference to FIG. 4, duplicated descriptions will not be repeated.

FIG. 6 is a block diagram illustrating an example of a black gamma voltage selector included in the gamma voltage generator of FIG. 3.

Referring to FIGS. 3 to 6, the black gamma voltage selector 230 includes a lookup table (LUT) 232, a calculator 234, and a determiner 236.

The LUT 232 can store a plurality of LUT voltage values corresponding to a plurality of reference points TP1 to TP4 which represent different magnitudes of the black load BL. The LUT voltage values can define the black gamma voltage V0. The LUT 232 can receive the black load BL from the load detector 220 and output a first corresponding voltage GV1 corresponding to the black load BL of a current frame. The LUT 232 can provide the first corresponding voltage GV1 to the calculator 234 and the determiner 236.

The calculator 234 can calculate a black load variation Δ BL based on the detected black load BL. The black load variation Δ BL can be a difference between the black load of the previous frame and the black load of the current frame. The calculator 234 can provide the black load variation Δ BL and a second corresponding voltage GV2 that corresponds to the black load of the previous frame to the determiner 236.

The determiner 236 can adaptively adjust an output of the black gamma voltage V0 based on the magnitude of the black load and the black load variation Δ BL. The determiner 236 can compare the black load variation Δ BL and a predetermined reference value that is a selected one of the black load BL. The determiner 236 can select the first corresponding voltage GV1 to be the black gamma voltage V0, when the black load variation is greater than the reference value. The determiner 236 can determine the black gamma voltage V0 by a linear interpolation between the second corresponding voltage GV2 and a voltage corresponding to the reference value, when the black load variation Δ BL is less than or equal to the reference value. In some embodiments, the determiner 236 maintains the output the black gamma voltage V0 having a specific voltage level, when the black load BL of the previous frame and the black load BL of the current frame are in a predetermined static load range. Accordingly, the determiner 236 can adaptively select (or determine) the black gamma voltage V0 based on the outputs of the calculator 234 and the LUT 232.

Since operations of the black gamma selector 230 are described above with reference to FIGS. 3 to 5, duplicated descriptions will not be repeated.

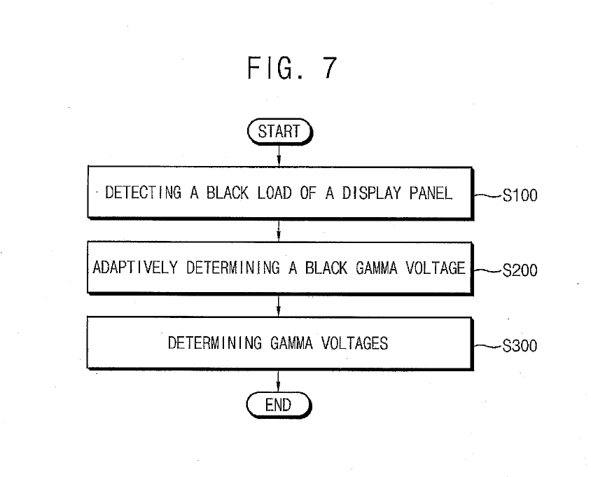

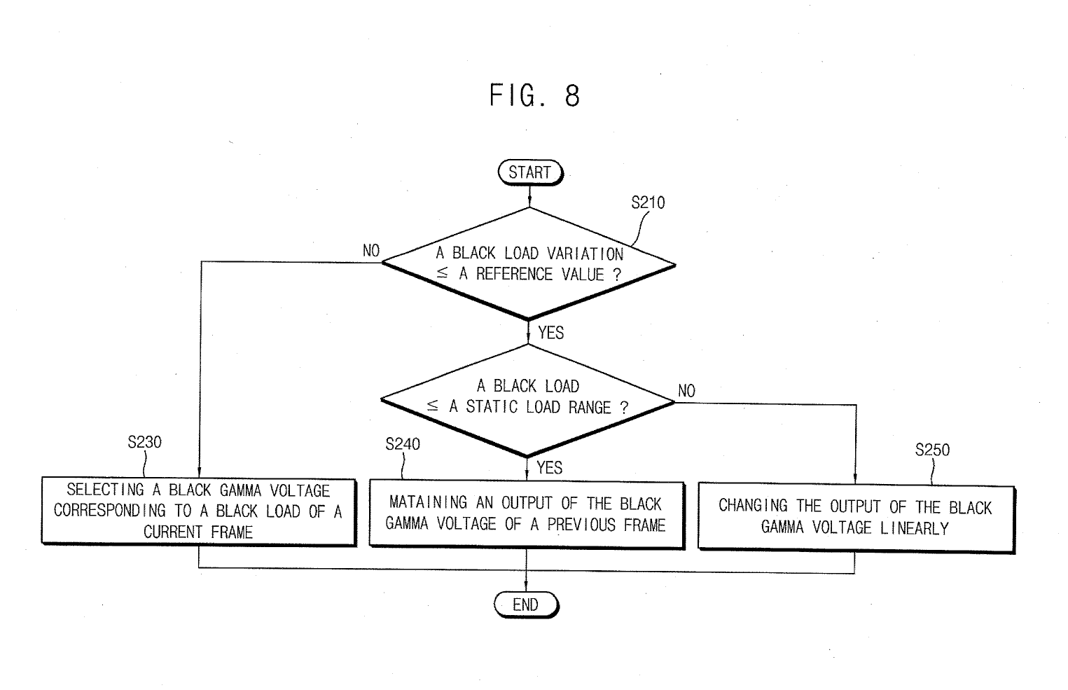

FIG. 7 is a flowchart of a method for driving a display device according to example embodiments. In some embodiments, the FIG. 7 procedure is implemented in a conventional programming language, such as C or C++ or another suitable programming language. The program can be stored on a computer accessible storage medium of the display device 1000, for example, a memory (not shown) of the display device 1000 or timing controller 360. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 7. The description of this paragraph applies to the embodiments shown in FIG. 8.

FIG. 8 is a flowchart illustrating an example of a method for determining a black gamma voltage in the driving method of FIG. 7.

Referring to FIGS. 1, 3, 4, 7, and 8, the method for driving the display device includes detecting a black load BL of a display panel 100 (S100), adaptively determining a black gamma voltage V0 of a current frame (S200), and determining a plurality of gamma voltages V1 to VN except for the black gamma voltage V0 based on input image data RGB (S300).

The black load BL of the display panel 100 can be detected S100. The black load BL can be a ratio of black pixels (or black image) among entire pixels (or the entire image). In some embodiments, the black load BL is detected by analyzing the input image data RGB. The black load BL can be detected every predetermined frame.

The black gamma voltage of the current frame which corresponds to a black grayscale can be adaptively determined based on the black load BL of the previous frame, the black load BL of the current frame, and a black load variation Δ BL S200. The black gamma voltage V0 can be determined based on the black load variation Δ BL and the magnitude of the black load BL.

In some embodiments, the black load variation Δ BL is compared to a predetermined reference value S210. If the black load variation Δ BL is greater than the reference value, the user does not recognize a black grayscale change. Thus, it is not necessary that the black gamma voltage V0 change linearly. In some embodiments, as represented at Table 3, when the black load variation Δ BL is greater than the reference value, the black gamma voltage V0 corresponding to the current frame black load BL can be selected non-linearly S230.

When the black load variation Δ BL is less than or equal to the reference value, the black load BL of the previous frame and the black load BL of the current frame can be compared to a predetermined static load range whether the black loads are in the static load range S220.

In some embodiments, when the black load of the previous frame and the black load of the current frame are in the static load range, as represented at Table 2, the output of the black gamma voltage of the previous frame can be maintained for the current frame S240.

In some embodiments, when the black load variation Δ BL is less than or equal to the reference value and at least one of the black load of the previous frame and the black load of the current frame exceeds the static load range, the black gamma voltage V0 can linearly change based on a linear interpolation S250.

Since methods for determining the black gamma voltage V0 are described above with reference to FIGS. 3 to 6, duplicated descriptions will not be repeated.

Accordingly, the black gamma voltage V0 can be adaptively controlled based on the detected black load BL.

The gamma voltages V1 to VN except for the black gamma voltage V0 can be determined based on the input image data RGB. Since methods for determining the gamma voltage V1 to VN are described above, duplicated descriptions will not be repeated.

The display device can generate data voltages applied to a display panel using the gamma voltages including the black gamma voltage and display images based on the data voltages.

As described above, the method for driving the display device according to example embodiments can adaptively and independently determine the black gamma voltage V0 based on the black load BL (or a grayscale change). Thus, color blurring and color band appearance by the emission delay can be improved.

The present embodiments can be applied to any display device and any system including the display device. For example, the present embodiments can be applied to televisions, computer monitors, laptop computers, digital cameras, cellular phones, smartphones, smart pads, personal digital assistants (PDAs), portable multimedia players (PMPs), MP3 players, navigation systems, game consoles, video phones, etc.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

What is claimed is:

1. A display device, comprising:
a display panel including a plurality of pixels;
a gamma voltage generator configured to i) determine a plurality of gamma voltages respectively corresponding to a plurality of grayscales, ii) independently determine a black gamma voltage corresponding to a black grayscale, and iii) output the black gamma voltage based on black load variation corresponding to the change of a black load between a plurality of frames; and
a display panel driver configured to drive the display panel based on the gamma voltages including the black gamma voltage.

2. The display device of claim 1, wherein the pixels include black pixels, and wherein the black load is a ratio of the black pixels to all the pixels.

3. The display device of claim 2, wherein the gamma voltage generator is configured to determine the black load based on the black load variation and a magnitude of the black load.

4. The display device of claim 1, wherein the gamma voltage generator includes:
a load detector configured to detect the black load in a predetermined frame;
a black gamma voltage selector configured to select the black gamma voltage based on the black load; and
a gamma voltage selector configured to select the gamma voltage except the black gamma voltage.

5. The display device of claim 4, wherein the load detector is further configured to receive image data from an external device and analyze the received image data so as to detect the black load.

6. The display device of claim 5, wherein the black gamma voltage selector is further configured to linearly change the black gamma voltage over a plurality of frames such that the black gamma voltage reaches a target black gamma voltage corresponding to the detected black load.

7. The display device of claim 6, wherein the black gamma voltage selector includes a lookup table (LUT) configured to store a plurality of LUT voltage values corresponding to a plurality of reference points corresponding to different magnitudes of the black load.

8. The display device of claim 7, wherein the black gamma voltage selector is further configured to linearly interpolate a black gamma voltage of an (N+1)th frame between a first voltage corresponding to an (N)th black load, that is the black load of an (N)th frame, and a second voltage corresponding to one of the reference points located nearest to an (N+1)th black load, that is the black load of the (N+1)th frame, where N is a positive integer.

9. The display device of claim 8, wherein the black gamma voltage selector is further configured to output the black gamma voltage of the (N+1)th frame and the black gamma voltage of the (N)th frame to have substantially the same value when the (N)th and (N+1)th black loads are within a predetermined static load range.

10. The display device of claim 8, wherein the black gamma voltage selector is further configured to output the black gamma voltage of the (N+1)th frame corresponding to the (N+1)th black load when the black load variation between the (N)th black load and the (N+1)th black load is greater than a predetermined reference value.

11. The display device of claim 7, wherein the black gamma voltage selector further includes:
a calculator configured to calculate a black load variation based on the detected black load; and
a determiner configured to adjust an output of the black gamma voltage based on a magnitude of the black load and the black load variation.

12. The display device of claim 4, wherein the black gamma voltage selector is further configured to select a black gamma voltage variation, corresponds to a change of the black gamma voltage between two frames, and the number of the frames in which the black gamma voltage changes linearly based on the black load variation.

13. The display device of claim 1, wherein the gamma voltage generator is further configured to decrease the black gamma voltage when the black load decreases.

14. The display device of claim 1, wherein each of the pixels includes an organic light-emitting diode (OLED).

15. The display device of claim 1, wherein the display panel driver includes:
a scan driver configured to provide a scan signal to the display panel;
a data driver configured to provide a data voltage generated based on the gamma voltages to the display panel; and
a timing controller configured to control the gamma voltage generator, the scan driver, and the data driver.

16. A method of driving a display device, comprising:
detecting a black load of a display panel;
determining a black gamma voltage of a current frame which corresponds to a black grayscale based on the black load of a previous frame and black load variation corresponding to the change of a black load between the frames; and
determining a plurality of gamma voltages except for the black gamma voltage based on input image data.

17. The method of claim 16, wherein the black gamma voltage is determined based on the black load variation and a magnitude of the black load.

18. The method of claim 16, wherein determining the black gamma voltage includes changing an output of the black gamma voltage via a linear interpolation method, when the black load variation is less than or substantially equal to a predetermined reference value.

19. The method of claim 18, wherein determining the black gamma voltage further includes maintaining the output of the black gamma voltage of the previous frame as the output of the black gamma voltage of the current frame, when the black load of the previous frame and the black load of the current frame are within a predetermined static load range.

20. The method of claim 19, wherein determining the black gamma voltage further includes selecting the black gamma voltage corresponding to the black load of the current frame, when the black load variation is greater than the reference value.
